(19) United States
(12) Patent Application Publication
(10) Pub. No.: US 2009/0128425 A1
(43) Pub. Date: May 21, 2009

(54) ANTENNA AND MOBILE COMMUNICATION DEVICE USING THE SAME

(75) Inventors: Hyun-Hak KIM, Osan (KR); Jong-Kweon Park, Daejeon (KR); Jung-Nam Lee, Daejeon (KR); Jin-Hee Ru, Daejeon (KR); Nam-Heung Kim, Suwon (KR); Seok-Min Woo, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/191,205

(22) Filed: Aug. 13, 2008

(30) Foreign Application Priority Data
Nov. 20, 2007 (KE) 10-2007-118445

(51) Int. Cl. H01Q 1/24; H01Q 1/00

(52) U.S. Cl. 343/702; 343/722

(57) ABSTRACT

There is provided a an antenna including: a first radiator having one end connected to a power feeding unit and receiving a signal within a first frequency band; a second radiator having one end connected to a ground surface and receiving a signal within a second frequency band; a first stub extending from the other end of the first radiator and finely adjusting the signal received by the first radiator; a second stub extending from the other end of the second radiator and finely adjusting the signal received by the second radiator; and a short-circuit unit electrically connecting the first radiator to the ground surface.

### CROSS-REFERENCE TO RELATED APPLICATIONS

This application claims the priority of Korean Patent Application No. 2007-0118445 filed on Nov. 20, 2007, in the Korean Intellectual Property Office, the disclosure of which is incorporated herein by reference.

### BACKGROUND OF THE INVENTION

1. Field of the Invention

The present invention relates to an antenna and a mobile communication device, and more particularly, to a configuration of an antenna that can tune received signals in different bands without affecting each other when receiving the signals and a mobile communication device that forms an MIMO antenna by using a plurality of antennas having the above configuration.

2. Description of the Related Art

The market for wireless mobile communications has been rapidly growing in recent years. Various kinds of multimedia services are required in wireless environment. At the same time, the amount of data to be transmitted has increased, and the speed of data transmission has increased. Therefore, a study on a method of efficiently using limited frequencies has been conducted. As part of such a study, research on a MIMO (multi input multi output) system that uses a channel in a spatial domain has been actively conducted.

MIMO technology uses multiple antennas at both a transmitter and a receiver to transmit a plurality of signals at the same time by using the same wireless channel. The MIMO technology increases channel capacity within limited frequency resources and provides a high data transmission rate. Further, the MIMO technology can increase the capacity of wireless data by tens of times without using additional frequencies because of a wide range of data transmitted with high reliability.

The capacity of the MIMO system is reduced due to connections between signals of a receiver. The connections between the signals received from different antenna devices are very important parameters in the MIMO system.

Since a large number of antenna devices are used in the MIMO system, when the antennas are mounted to a mobile terminal, the distance between the antennas becomes very short, and this may cause stronger connections therebetween. As the antennas are connected to each other, a relatively low gain is obtained.

### SUMMARY OF THE INVENTION

An aspect of the present invention provides a configuration of an antenna in which frequency signals in different bands do not affect each other when a plurality of small antennas are formed in a mobile communication device and a mobile communication device that can increase isolation between the plurality of antennas having the above configuration when arranging the plurality of antennas.

An aspect of the present invention also provides an antenna including: a first radiator having one end connected to a power feeding unit and receiving a signal within a first frequency band; a second radiator having one end connected to a ground surface and receiving a signal within a second frequency band; a first stub extending from the other end of the first radiator and finely adjusting the signal received by the first radiator; a second stub extending from the other end of the second radiator and finely adjusting the signal received by the second radiator; and a short-circuit unit electrically connecting the first radiator to the ground surface.

The first and second radiators may be flat. The first radiator and the second radiator may be arranged in the same plane direction.

At least one of the first and second radiators may include at least one vertically bent part.

The first radiator may include a first region connected to the power feeding unit and a second region vertically extending from the first region. The second radiator may be arranged in parallel with the first region of the first radiator. The short-circuit unit may be connected to the first region.

The first stub and the second stub may be flat. The first stub and the second stub may extend toward the plane directions of the first radiator and the second radiator, respectively, so that the first and second stubs meet the first and second radiators, respectively, at right angles.

The first stub and the second stub may be arranged so that plane directions of the first stub and the second stub are perpendicular to each other.

According to another aspect of the present invention, there is provided a mobile communication device including: a board; at least two antennas formed at the board; power feeding units formed on the board and individually connected to the at least two antennas; and a ground surface formed at the board and having slots formed therein to isolate the at least two antennas from each other, wherein each of the at least two antennas includes: a first radiator having one end connected to the power feeding unit and receiving a signal within a first frequency band; a second radiator having one end connected to the ground surface and receiving a signal within a second frequency band; a first stub extending from the other end of the first radiator and finely adjusting the signal received by the first radiator; a second stub extending from the other end of the second radiator and finely adjusting the signal received by the second radiator; and a short-circuit unit electrically connecting the first radiator to the ground surface.

The at least two antennas may include four antennas respectively formed at the four edges of the board.

The first and second radiators may be arranged perpendicular to the board surface.

The first and second radiators may flat. The first radiator and the second radiator may be arranged in the same plane direction.

At least one of the first radiator and the second radiator may include at least one vertically bent part.

The first radiator may include a first region connected to the power feeding unit and a second region vertically extending from the first region. The second radiator may be arranged in parallel with the first region of the first radiator. The short-circuit unit may be connected to the first region. The first stub and the second stub may be flat.

The first stub and the second stub may extend toward the plane directions of the first radiator and the second radiator, respectively, so that the first and second stubs meet the first and second radiators, respectively, at right angles.

The first stub and the second stub may be arranged so that plane directions of the first and second stubs are perpendicular to each other.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration view illustrating an antenna according to an exemplary embodiment of the present invention.

FIG. 2A is a graph illustrating return loss according to a change in length of a first stub in the antenna according to the exemplary embodiment of the invention shown in FIG. 1.

FIG. 2B is a graph illustrating return loss according to a change in length of a second stub in the antenna according to the exemplary embodiment of the invention shown in FIG. 1.

FIG. 3 is a view illustrating a configuration of a board and antennas that are formed in a mobile communication device according to an exemplary embodiment of the present invention.

### DETAILED DESCRIPTION OF THE PREFERRED EMBODIMENT

Exemplary embodiments of the present invention will now be described in detail with reference to the accompanying drawings.

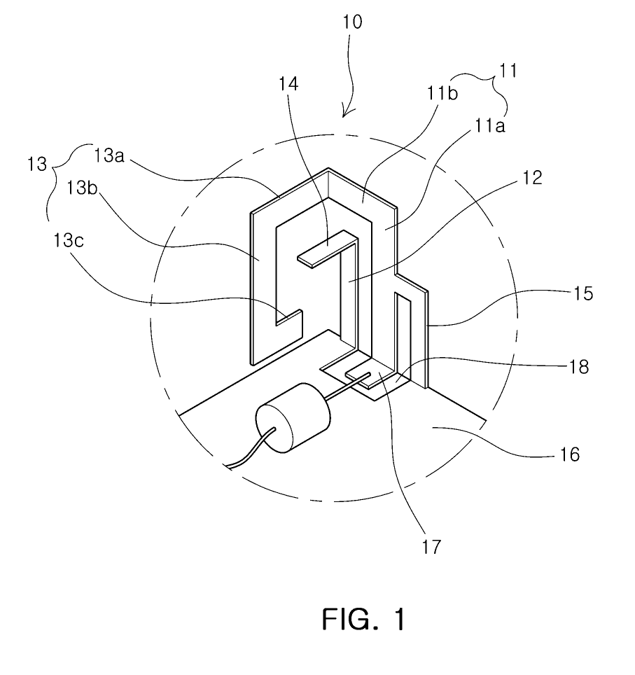

FIG. 1 is a configuration view illustrating an antenna according to an exemplary embodiment of the present invention.

Referring to FIG. 1, the antenna according to the embodiment of the invention may include a first radiator 11, a second radiator 12, a first stub 13, a second stub 14, and a short-circuit unit 15.

The first radiator 11 has one end connected to a power feeding unit 17 and may have an electrical length to receive a first frequency signal.

In this embodiment, the first radiator 11 may be flat. The first radiator 11 may include a first region 11a connected to the power feeding unit 17 and a second region 11b vertically connected to the first region 11a.

One end of the short-circuit unit 15 is connected to the first region 11a of the first radiator 11 so that the first radiator 11 can be connected to a ground surface 16.

The second radiator 12 has one end connected to the ground surface 16 and may have an electrical length to receive a second frequency signal.

In this embodiment, the second radiator 12 may be flat. The first radiator 11 and the second radiator 12 may be arranged so that a plane direction of the first radiator 11 is the same as that of the second radiator 12.

The second radiator 12 may be arranged in parallel with the first region 11a of the first radiator 11.

In this embodiment, the first radiator 11 may be only connected to the power feeding unit 17 and the second radiator 12 may not be connected to the power feeding unit 17. When one of the two radiators is connected to the power feeding unit and the other is connected to the ground surface, a signal flows along the ground surface. Therefore, even though the gain is slightly reduced, appropriate isolation between channels is provided, and it is possible to freely tune the received frequency signal.

In this embodiment, the first radiator 11 has one bent part, and the second radiator 12 does not a bent part. When one of the first and second radiators having the same plane direction has one bent part, the first stub 13 connected to the first radiator 11 and the second stub 14 connected to the second radiator 12 may have plane directions at right angles to each other. Therefore, the number of bent parts formed in the first radiator and the second radiator may vary.

As such, when the bent parts are formed in the first radiator and the second radiator, the antenna can be reduced in size.

In this embodiment, the first frequency signal that is received by the first radiator 11 may be at 2.45 GHz, and the second frequency signal that is received by the second radiator 12 may be at 5.2 GHz.

The first stub 13 may extend from the other end of the first radiator 11 toward the plane direction of the first radiator 11 so that the first stub 13 and the first radiator 11 meet at right angles.

In this embodiment, the first stub 13 may be flat. The first stub 13 may include a first region 13a connected to the first radiator 11, a second region 13b extending from the first region 13a in a perpendicular direction thereto, and a third region 13c extending from the second region 13b in a perpendicular direction thereto.

It is possible to finely adjust the first frequency signal received by the first radiator 11 by controlling the length of the first stub 13.

The second stub 14 may extend from the other end of the second radiator 12 in the plane direction of the second radiator 14 so that the second stub 14 and the second radiator 12 meet at right angles. It is possible to finely adjust the second frequency signal received by the second radiator 12 by controlling the length of the second stub 14.

In this embodiment, the second stub 14 may be flat. The first stub 13 and the second stub 14 may be arranged so that the plane directions thereof intersect at right angles. The arrangement between the first stub and the second stub may be determined according to the configurations of the first and second radiators. That is, in this embodiment, the first radiator and the second radiator are arranged in the same plane direction, and one vertically bent part is formed in the first radiator. Therefore, the first stub 13 vertically extending from the first radiator 11 and the second stub 14 vertically extending from the second radiator 12 may have the plane directions at right angles to each other.

Since the plane direction of the first stub and the second stub intersect at right angles, when the first and second radiators receive the frequency signals through different channels from each other, the first and second radiators may not affect each other to thereby increase the gain.

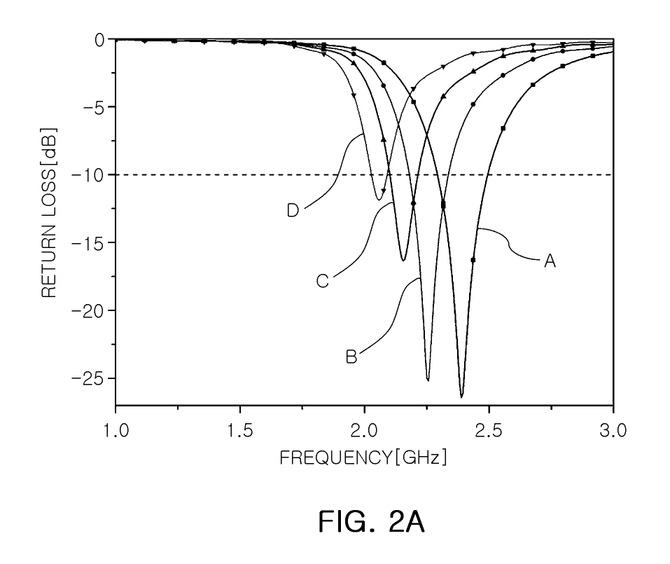

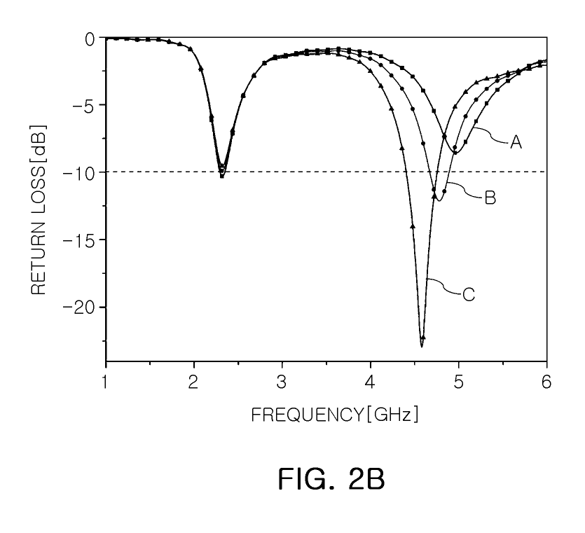

FIG. 2A is a graph showing return loss according to a change in length of a first stub in the antenna according to the embodiment of FIG. 1. FIG. 2B is a graph showing return loss according to a change in length of a second stub in the antenna according to the embodiment of FIG. 1.

In FIG. 2A, the graph shows return loss according to the change in length by varying the length of the first stub 13 of FIG. 1.

In this embodiment, the first stub 13 can finely adjust the frequency signal at approximately 2.45 GHz that is received by the first radiator 11. That is, when the first stub is 2 mm (A), the resonance frequency may range from 2.3 to 2.5 GHz. When the first stub is 3 mm (B), the resonance frequency may range from 2.2 to 2.4 GHz. When the first stub is 4 mm (C), the resonance frequency may range from 2.1 to 2.25 GHz. When the first stub is 5 mm (D), the resonance frequency may range from 2.0 to 2.1 GHz.

However, a frequency domain of the frequency signal received by the second radiator may not be affected much.

In FIG. 2B, the graph shows return loss according to the change in length by varying the length of the second stub 14 of FIG. 1

In this embodiment, the second stub 14 can finely adjust the frequency signal at approximately 5.2 GHz that is received by the second radiator 12. That is, when the second stub is 3 mm (A), the resonance frequency may be approximately 5.0 GHz. When the second stub is 4 mm (B), the resonance frequency may range from 4.7 to 4.9 GHz. When the first stub is 5 mm (C), the resonance frequency may range from 4.5 to 4.8 GHz. At this time, it can be seen that the resonance frequency at approximately 2.45 GHz in a frequency domain of the frequency signal received by the first radiator changes little.

As such, in the antenna that has the radiators according to this embodiment, it is possible to fine adjust a frequency signal within a corresponding domain without affecting a frequency signal in a different band.

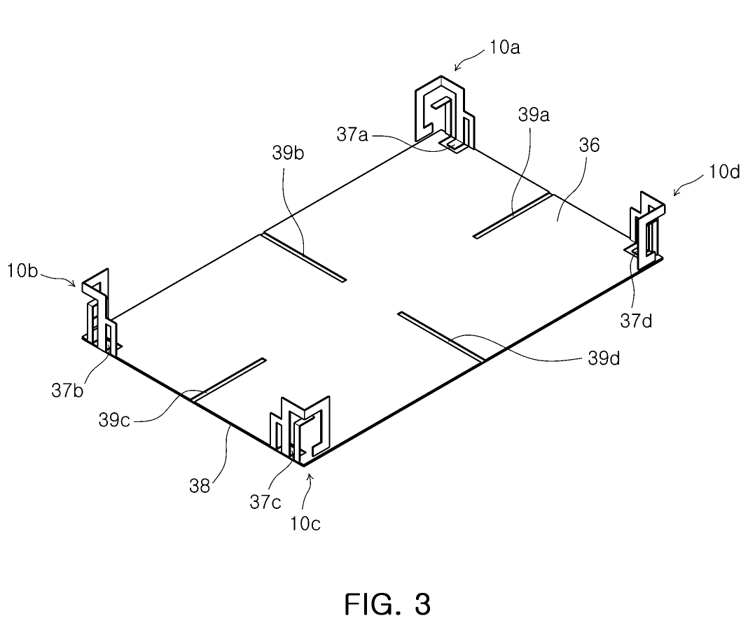

FIG. 3 is a view illustrating the configuration of a board and antennas that are included in a mobile communication device according to an exemplary embodiment of the present invention.

Referring to FIG. 3, a mobile communication device according to this embodiment of the invention may include a board 38, four antennas 10a, 10b, 10c, and 10d formed at edges of the board 38, power feeding units 37a, 37b, 37c, and 37d formed on the board and connected to the four antennas 10a, 10b, 10c, and 10d, respectively, and a ground surface 36 formed on the board and having slots 39a, 39b, 39c, and 39d for isolating the four antennas from each other.

In this embodiment, antennas may be separately formed at the four edges of the board 38. Each of the antennas forms one antenna system and serves as a MIMO antenna.

In order to improve isolation between the antennas mounted to the edges of the board, the plurality of slots 39a, 39b, 39c, and 39d may be formed in the ground surface. Since it is possible to detour a path of the current that directly flows toward the neighboring antennas through the ground surface by using the individual slots, the isolation between the antennas can be improved.

Each of the four antennas may have a first radiator, a second radiator, a first stub, a second stub, and a short-circuit unit. The first radiator has one end connected to the power feeding unit and receives a signal within a first frequency band. The second radiator has one end connected to the ground surface and receives a signal within a second frequency band. The first stub extends from the other end of the first radiator and finely adjusts the signal received by the first radiator. The second stub extends from the other end of the second radiator and finely adjusts the signal received by the second radiator. The short-circuit unit connects the first radiator to the ground surface.

The first radiator has one end connected to the power feeding unit and may have an electrical length to receive a first frequency signal. Each of the antennas will be described on the basis of the antenna described in FIG. 1.

In this embodiment, the first radiator 11 may flat. The first radiator 11 may include the first region 11a connected to the power feeding unit 17 and the second region 11b vertically connected to the first region 11a.

One end of the short-circuit unit 15 is connected to the first region 11a of the first radiator 11 so that the first radiator 11 can be connected to the ground surface 16.

The second radiator 12 has one end connected to the ground surface 16 and may have an electrical length to receive the second frequency signal.

In this embodiment, the second radiator 12 may be flat. The first radiator 11 and the second radiator 12 may be arranged so that a plane direction of the first radiator 11 is the same as that of the second radiator 12.

The second radiator 12 may be arranged in parallel with the first region 11a of the first radiator 11.

In this embodiment, the first radiator 11 may be only connected to the power feeding unit 17, and the second radiator 12 may not be connected to the power feeding unit 17. When one of the two radiators is connected to the power feeding unit and the other is only connected to the ground surface, a signal flows along the ground surface. Therefore, even though the gain is slightly reduced, appropriate isolation between channels is provided, and it is possible to freely tune the received frequency signal.

In this embodiment, the first radiator 11 has one bent part, and the second radiator 12 does not a bent part. When one of the first and second radiators having the same plane direction has one bent part, the first stub 13 connected to the first radiator 11 and the second stub 14 connected to the second radiator 12 may have plane directions at right angles to each other. Therefore, the number of bent parts that may be formed on the first radiator and the second radiator may vary.

As such, when the bent parts are formed on the first radiator and the second radiator, the antenna can be reduced in size.

In this embodiment, the first frequency signal that is received by the first radiator 11 may be at 2.45 GHz, and the second frequency signal that is received by the second radiator 12 may be at 5.2 GHz.

Further, in this embodiment, the first and second radiators may be vertically arranged relative to the board surface. In this way, the entire area of the board mounted to the inside of the mobile communication device can be decreased to thereby reduce the size of the mobile communication device.

The first stub 13 may extend from the other end of the first radiator 11 in the plane direction of the first radiator 11 so that the first stub 13 and the first radiator 11 meet at right angles.

In this embodiment, the first stub 13 may be flat. The first stub 13 may include a first region 13a connected to the first radiator 11, a second region 13b extending from the first region 13a in a perpendicular direction thereto, and a third region 13c extending from the second region 13b in a perpendicular direction thereto.

It is possible to finely adjust the first frequency signal received by the first radiator 11 by controlling the length of the first stub 13.

The second stub 14 may extend from the other end of the second radiator 12 in the plane direction of the second radiator 12 so that the second stub 14 and the second radiator 12 meet at right angles. It is possible to finely adjust the second frequency signal received by the second radiator 12 by controlling the length of the second stub 14.

In this embodiment, the second stub 14 may be flat. The first stub 13 and the second stub 14 may be arranged so that plane directions thereof intersect at right angles. The arrangement between the first stub and the second stub may be determined according to the configurations of the first and second radiators. That is, in this embodiment, the first radiator and the second radiator are arranged so that the first and second radiators have the same plane direction, and one vertically bent part is formed in the first radiator. Therefore, the first stub 13 vertically extending from the first radiator 11 and the second stub 14 vertically extending from the second radiator 12 may have plane directions at right angles to each other.

Since the plane directions of the first stub and the second stub intersect at right angles, when the first and second radiators receive the frequency signals through different channels from each other, the first and second radiators may not affect each other to thereby increase the gain.

As set forth above, according to exemplary embodiments of the invention, it is possible to obtain an antenna with high gain with respect to frequency signals in different bands while the antenna has a small size and to maintain high isolation between antennas in a mobile communication device using a plurality of antennas having the above configuration.

While the present invention has been shown and described in connection with the exemplary embodiments, it will be apparent to those skilled in the art that modifications and variations can be made without departing from the spirit and scope of the invention as defined by the appended claims.

What is claimed is:

1. An antenna comprising:
a first radiator having one end connected to a power feeding unit and receiving a signal within a first frequency band;
a second radiator having one end connected to a ground surface and receiving a signal within a second frequency band;
a first stub extending from the other end of the first radiator and finely adjusting the signal received by the first radiator;
a second stub extending from the other end of the second radiator and finely adjusting the signal received by the second radiator; and
a short-circuit unit electrically connecting the first radiator to the ground surface.

2. The antenna of claim 1, wherein the first and second radiators are flat.

3. The antenna of claim 2, wherein the first radiator and the second radiator are arranged in the same plane direction.

4. The antenna of claim 2, wherein at least one of the first and second radiators comprises at least one vertically bent part.

5. The antenna of claim 4, wherein the first radiator comprises a first region connected to the power feeding unit and a second region vertically extending from the first region.

6. The antenna of claim 5, wherein the second radiator is arranged in parallel with the first region of the first radiator.

7. The antenna of claim 5, wherein the short-circuit unit is connected to the first region.

8. The antenna of claim 2, wherein the first stub and the second stub are flat.

9. The antenna of claim 8, wherein the first stub and the second stub extend toward the plane directions of the first radiator and the second radiator, respectively, so that the first and second stubs meet the first and second radiators, respectively, at right angles.

10. The antenna of claim 8, wherein the first stub and the second stub are arranged so that plane directions of the first stub and the second stub are perpendicular to each other.

11. A mobile communication device comprising:
a board;
at least two antennas formed at the board;
power feeding units formed on the board and individually connected to the at least two antennas; and
a ground surface formed at the board and having slots formed therein to isolate the at least two antennas from each other,
wherein each of the at least two antennas comprises:
a first radiator having one end connected to the power feeding unit and receiving a signal within a first frequency band;
a second radiator having one end connected to the ground surface and receiving a signal within a second frequency band;
a first stub extending from the other end of the first radiator and finely adjusting the signal received by the first radiator;
a second stub extending from the other end of the second radiator and finely adjusting the signal received by the second radiator; and
a short-circuit unit electrically connecting the first radiator to the ground surface.

12. The mobile communication device of claim 11, wherein the at least two antennas comprise four antennas respectively formed at the four edges of the board.

13. The mobile communication device of claim 11, wherein the first and second radiators are arranged perpendicular to the board surface.

14. The mobile communication device of claim 11, wherein the first and second radiators are flat.

15. The mobile communication device of claim 14, wherein the first radiator and the second radiator are arranged in the same plane direction.

16. The mobile communication device of claim 14, wherein at least one of the first radiator and the second radiator comprises at least one vertically bent part.

17. The mobile communication device of claim 16, wherein the first radiator comprises a first region connected to the power feeding unit and a second region vertically extending from the first region.

18. The mobile communication device of claim 17, wherein the second radiator is arranged in parallel with the first region of the first radiator.

19. The mobile communication device of claim 17, wherein the short-circuit unit is connected to the first region.

20. The mobile communication device of claim 14, wherein the first stub and the second stub are flat.

21. The mobile communication device of claim 20, wherein the first stub and the second stub extend toward the plane directions of the first radiator and the second radiator, respectively, so that the first and second stubs meet the first and second radiators, respectively, at right angles.

22. The mobile communication device of claim 20, wherein the first stub and the second stub are arranged so that plane directions of the first and second stubs are perpendicular to each other.
